(19) United States
(12) Patent Application Publication
(10) Pub. No.: US 2006/0017279 A1
(43) Pub. Date: Jan. 26, 2006

(54) Self-adhesive file bag

(76) Inventor: Ming Han Wu, Tainan City (TW)

Correspondence Address: PRO-TECTOR INTERNATIONAL SERVICES, 20775 NORADA CT., SARATOGA, CA, 95070, US

(21) Appl. No.: 11/148,628

(22) Filed: Jun. 8, 2005

(30) Foreign Application Priority Data
Jul. 22, 2004 (TW) 93122107

(51) Int. Cl. B65D 33/16; B42D 15/00

(52) U.S. Cl. 283/116

(57) ABSTRACT

A self-adhesive plastic file bag having three closed sides and one open side, and a sealing tape provided in the open side and operatable to close/open said open side. The sealing tape is formed of a strippable strip and a double-sided adhesive tape, having two distal ends respectively sealed to the two opposite closed sides of the self-adhesive file bag. When sealing the open side, break one end of the strippable strip from the respective close side, and then expel air out of the bag, and then pull the strippable strip away from the double-sided adhesive tape step by step while expelling air out of the bag and sealing the double-sided adhesive tape to close the open side of the bag.

### BACKGROUND OF THE INVENTION

1. Field of the Invention

The present invention relates to a file bag and more particularly, to a self-adhesive file bag that can be completely sealed.

2. Description of the Related Art

A self-adhesive sealing tape 13, as shown in FIG. 1C, is comprised of a double-sided tape 131 and a strippable strip 132. This design of sealing tape 13 is extensively used in traditional file bags, called self-adhesive file bag, to close the open side of the file bag. For example, the file bag 1, as shown in FIG. 1A, used worldwide for storing many things (such as books magazines`greetings cards . . . ). Being unable to well protect the storage file is the fatal drawback of the file bag 1, because the open side 52 of the file bag 1 can't be sealed completely. As illustrated in FIGS. 1A and 1B, the file bag 1 is a rectangular plastic bag having three closed sides 11 and an open side 12. The file bag 1 has a cover flap 121 suspended from the open side 12, and a self-adhesive sealing tape 13 transversely provided at the inner side of the cover flap 121 remote from the open side 12. When in use, the file 20 is inserted through the open side 12 into the inside of the file bag 1 (see FIGS. 2A and 2B), and then the cover flap 121 is turned inwards and covered over the open side 12 after removing the strippable strip from the double-sided tape 131 (see FIGS. 2C and 2D). When sealed, the cover flap 121 prohibits the storage file 20 from falling out of the file bag 1. However, because two openings 122 are left at two opposite lateral sides after the cover flap 121 has been closed and sealed (see FIG. 2D), water or dust can pass through the openings 122 to wet or contaminate the storage file 20. Therefore, this structure of file bag 1 cannot protect the storage items against dust and water. Because the aforesaid file bag has the fatal drawback of being unable to well protect the storage file, lamination film for copy protection is developed.

In order to protect the file (photo, paper document) against dust and moisture, the file may be covered with plastic material by a laminator. As illustrated in FIGS. 3A, 3B and 3C, a plastic film 3 is folded up, and then the file 2 is inserted in between the first half 3a and the second half 3b of the folded plastic film 3, and then the first half 3a and the second half 3b of the folded plastic film 3 are peripherally sealed. As illustrated in FIGS. 3B and 3C, when laminated, the file 2 is well protected against the contamination of dust and moisture. To the protection of file, lamination technique provides the user with another choice. Therefore, the use of a lamination film becomes an important file protection technique that has been extensively used worldwide. However, the bonding between the lamination film and the file causes a trouble to the user because the lamination film cannot be removed from the file when bonded to the file. Due to this problem, lamination film cannot be used to protect files that must have the outer appearance kept intact.

Further, it is not economical to use a laminator, which is expensive to buy and use. Further, when wishing to keep the plastically laminated file 2 in a ring binder, the plastically laminated file 2 must be punched to provide a line of punch holes for installation.

As indicated above, the development of lamination technique is just because the file bags cannot completely closed in a watertight status. This is also the common problem of currently commercially available self-adhesive strip type plastic packing bags in the world.

Therefore, it is desirable to provide a self-adhesive file bag that eliminates the aforesaid drawbacks.

### SUMMARY OF THE INVENTION

The present invention has been accomplished under the circumstances in view.

According to one aspect of the present invention, the self-adhesive file bag comprises a rectangular plastic bag body formed of an upper layer and a bottom layer and having three closed sides and one open side between two opposite closed sides of said three closed sides, and a sealing tape provided in the open side and operatable to close/open said open side. The sealing tape is formed of a strippable strip and a double-sided adhesive tape, having two distal ends respectively sealed to the two opposite closed sides of the self-adhesive file bag.

By means of the feature that the sealing tape has the two distal ends respectively bonded to the two opposite closed sides of the self-adhesive file bag, the open side of the self-adhesive file bag can be closed completely. Also, by means of the sealing function of the sealing tape, the self-adhesive file bag won't leave two openings at two opposite lateral sides as traditional self-adhesive file bag.

With the step-by-step strippable strip separating and step-by-step air expelling method, the inside air can be smoothly expelled out of the file bag, and therefore the file bag will be kept in a flat manner without inflation, at the same time, the four sides are completely sealed. When the four sides of the file bag are sealed, the storage file is well protected against water and dust.

According to another aspect of the present invention, through holes are aligned in the open side of the self-adhesive file bag in front of the sealing tape so that the self-adhesive file bag can be fastened to a ring binder.

### BRIEF DESCRIPTION OF THE DRAWINGS

FIG. 1A illustrates a file bag according to the prior art.

FIG. 1B is a side view in section of the file bag according to the prior art.

FIG. 1C is an enlarged view of a part of FIG. 1B showing the structure of the self-adhesive sealing tape.

FIG. 2A corresponds to FIG. 1A, showing a file inserted into the file bag.

FIG. 2B corresponds to FIG. 1B, showing the file received inside the file bag.

FIG. 2C is similar to FIG. 2B but showing the cover flap covered over the open side and how the openings are formed.

FIG. 2D is similar to FIG. 2A but showing the cover flap closed and how the openings are formed.

FIG. 3A is a schematic drawing showing a file inserted into a folded plastic film according to the prior art.

FIG. 3B is a front view showing the plastic film sealed to the file according to the prior art.

FIG. 3C is a side view in section of FIG. 3B.

FIG. 4A is a perspective view of a self-adhesive file bag according to the present invention.

FIG. 4B is a side view of the self-adhesive file bag according to the present invention.

FIG. 4C is a front view in section in an enlarged scale of the file bag according to the present invention, showing the status of the strippable strip before separating from the double-sided adhesive tape.

FIG. 4D is similar to FIG. 4C but showing the strippable strip separated from the double-sided adhesive tape and the upper layer is not sealed to the bottom layer yet.

FIG. 4E is an enlarged view of a part of FIG. 4A, showing how the distal ends of the sealing tape join together with the two opposite closed sides of the file bag.

FIG. 5 is a schematic drawing showing the sealing operation of the present invention.

FIG. 6A is a schematic drawing showing the sealing and expelling operation of the present invention (I).

FIG. 6B is a schematic drawing showing the sealing and expelling operation of the present invention (II).

FIG. 6C is a schematic drawing showing the sealing and expelling operation of the present invention (III).

FIG. 6D is a schematic drawing showing the sealing and expelling operation of the present invention (IV).

FIG. 7 is similar to FIG. 4D but showing the upper layer sealed to the bottom layer.

FIG. 8 is a schematic drawing showing the sealing and expelling operation of the present invention.

FIG. 9A illustrates an alternate form of the self-adhesive file bag connectable to a ring binder according to the present invention.

FIG. 9B corresponds to FIG. 9A, showing the split rings of the ring binder opened.

FIG. 9C corresponds to FIG. 9B, showing the self-adhesive file bag installed to the ring binder.

FIG. 10A illustrates another alternate form of the self-adhesive file bag connectable to a ring binder according to the present.

FIG. 10B corresponds to FIG. 10A, showing the self-adhesive file bag installed to the ring binder.

FIG. 11A illustrates still another alternate form (two distal ends cut off) of the self-adhesive file bag connectable to a ring binder with two end clamping lugs according to the present invention.

FIG. 11B corresponds to FIG. 11A, showing the self-adhesive file bag installed to the ring binder with two end clamping lugs.

FIG. 11C is a schematic drawing showing a second self-adhesive file bag partially inserted into the open side of a first self-adhesive file bag.

FIG. 12A is a plain view of still another alternate form of the present invention, showing the open side of the self-adhesive file bag provided with a tear-off line and a strippable portion.

FIG. 12B corresponds to FIG. 12A, showing the status of the self-adhesive file bag after removal of the strippable portion.

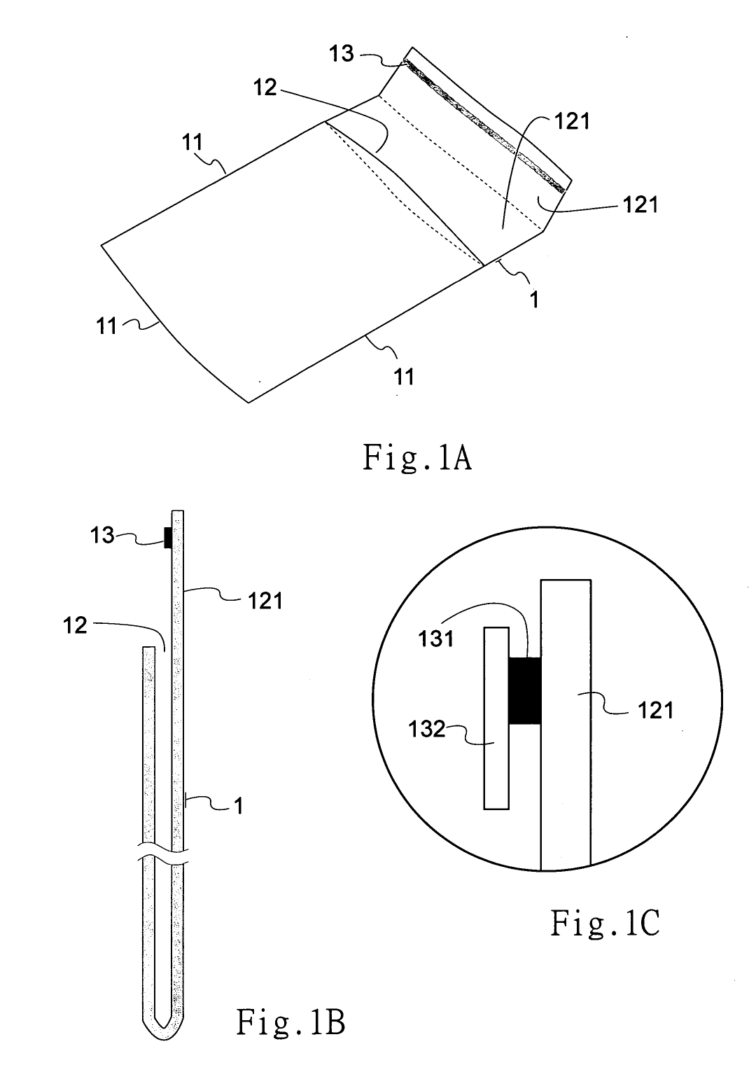

### DETAILED DESCRIPTION OF THE PREFERRED EMBODIMENT

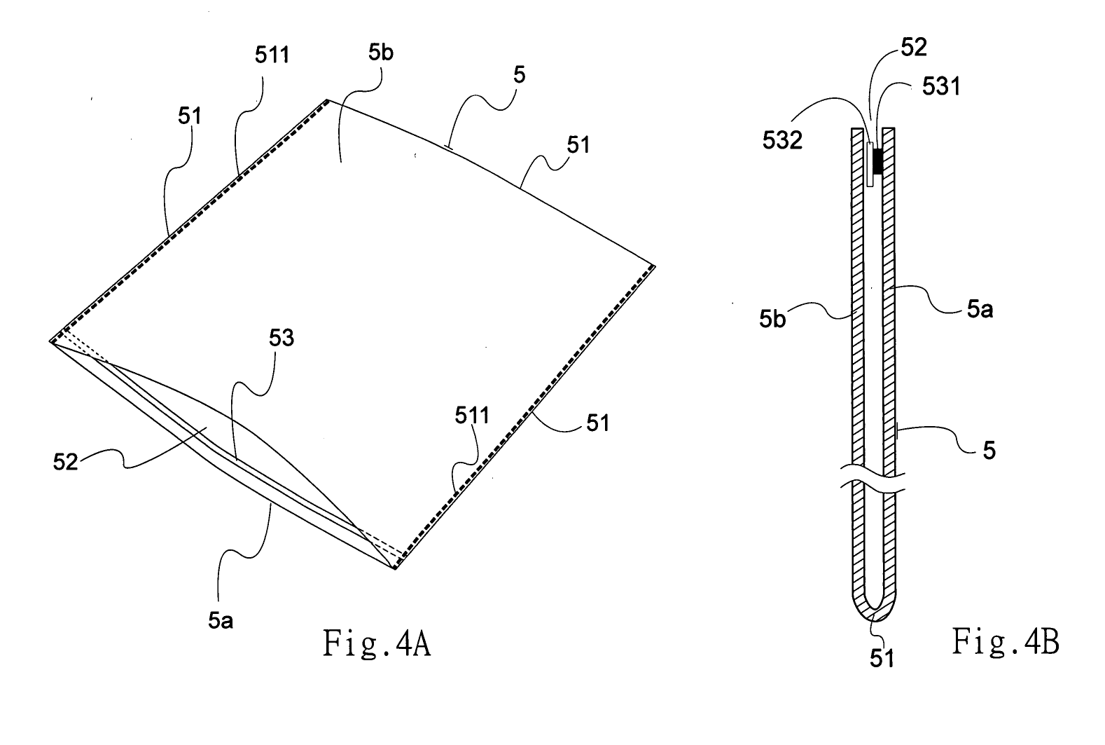

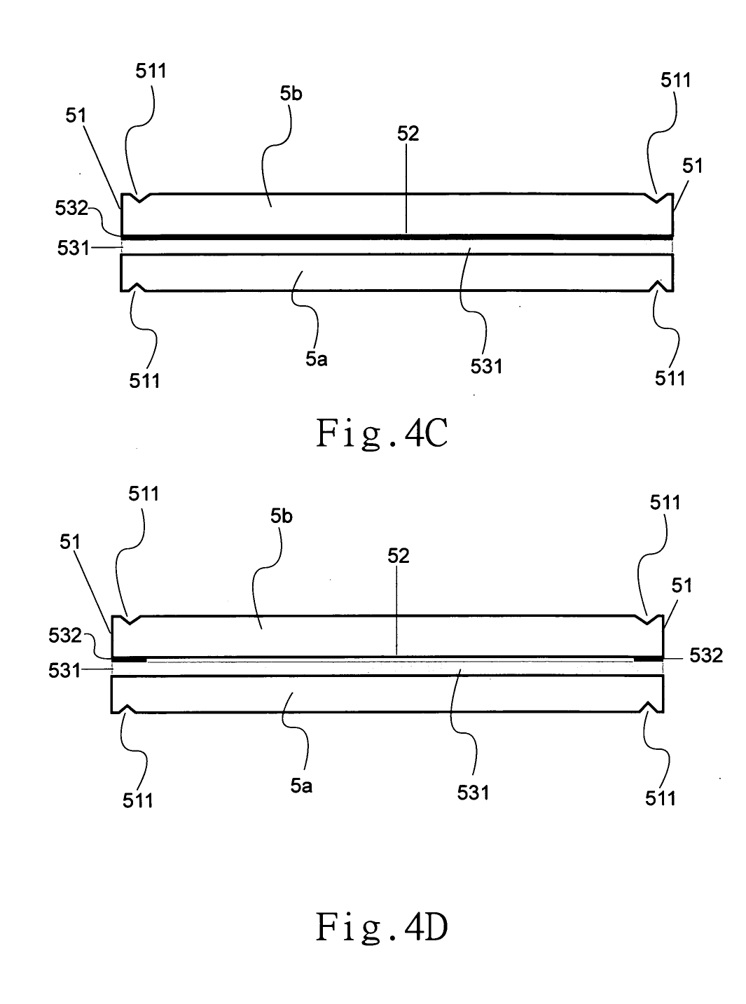

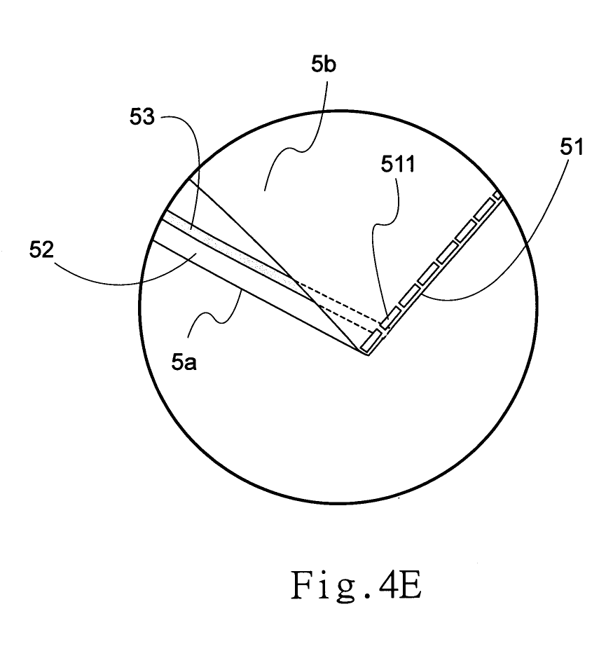

Referring to FIG. 4A, the self-adhesive file bag, referenced by 5, has a rectangular plastic bag body, which is formed of an upper layer 5b and a bottom layer 5a and has three closed sides 51 and one open side 52. A sealing tape 53 is provided in the open side 52 and operatable to close/open the open side 52. The sealing tape 53 is comprised of a strippable strip 532 and a double-sided adhesive tape 531 (see FIG. 4B). The strippable strip 532 and the double-sided adhesive tape 531 are transversely affixed to the inside wall of the bottom layer 5a corresponding to the open side 52. The width of the strippable strip 532 is greater than the double-sided adhesive tape 531 so that the user can conveniently separate the strippable strip 532 from the double-sided adhesive tape 531.

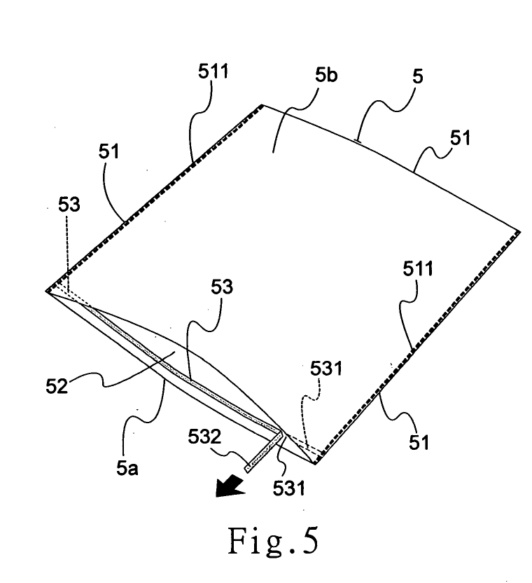

As indicated above, after inserting paper documents (not shown) through the open side 52 into the file bag 5, the user can insert the hand into the inside of the file bag 5 and conveniently separate the strippable strip 532 from the double-sided adhesive tape 531 from one end toward the other (see FIG. 5).

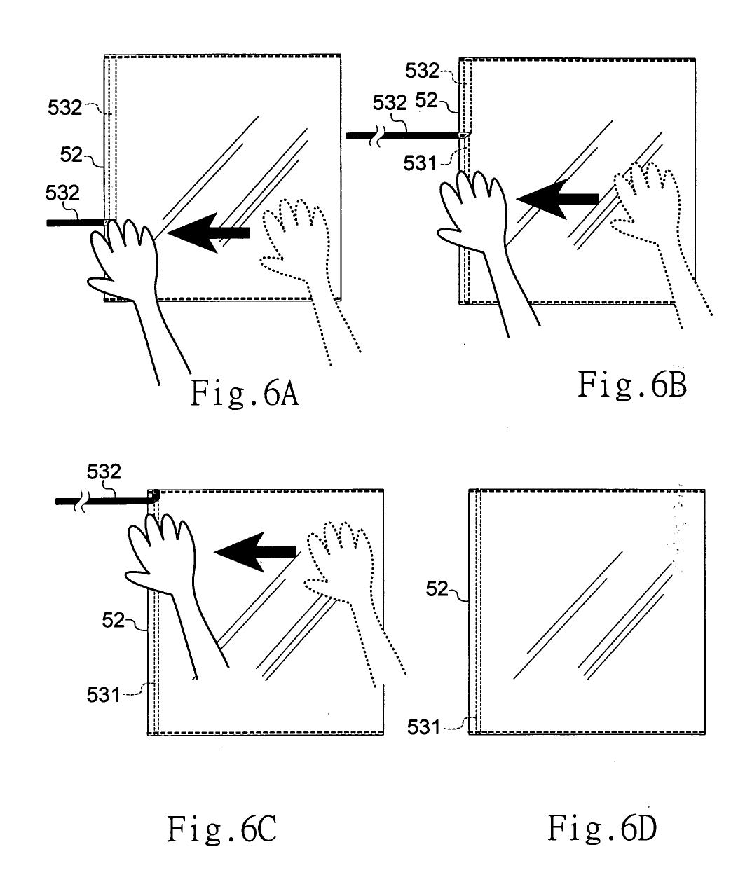

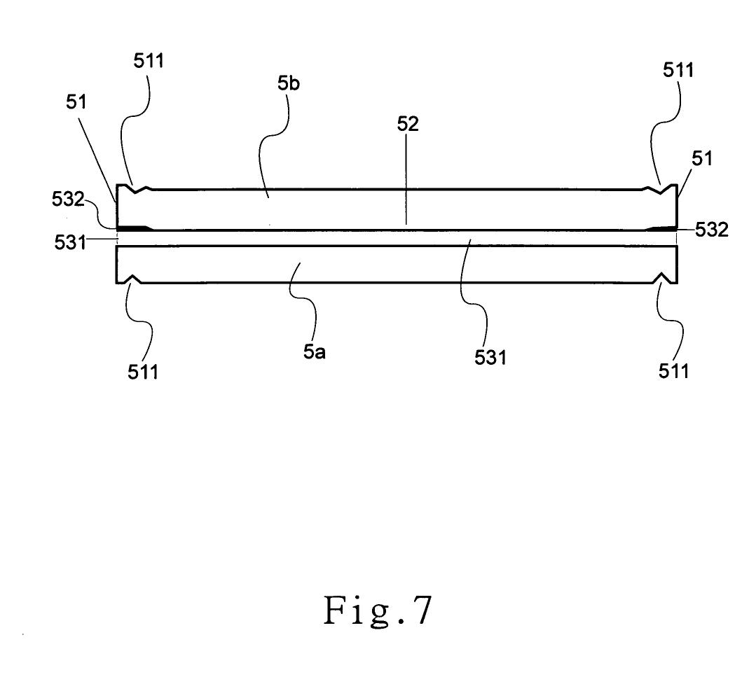

At the initial stage, tear one end of the strippable strip 532 from the respective sealing line 511 and turn the broken end 90 angles toward the outside of the file bag 5 (see FIG. 5). At this time, the double-sided adhesive tape 531 is still kept away from the upper layer 5b. Then, move the hand over the file bag 5 against a flap surface in the direction from the other close side 51 (the bottom close side) toward the open side 52 to expel air out of the file bag 5 (see FIG. 6A). When moving the hand over the self-adhesive file bag 5 to flatten the self-adhesive file bag 5, the part of the open side 52 where the strippable strip 532 has been separated from the double-sided adhesive tape 531 will be sealed by the double-sided adhesive tape 531 (see FIG. 6B). So, the double-sided adhesive tape 531 embedded on the bottom layer 5a will be sealed to the upper layer 5b to close the open side 52. Thereafter, repeating the aforesaid procedure to expel air out of the file bag 5 while separating the strippable strip 532 from the file bag 5 (see FIGS. 6A, 6B, and 6C). After removing the strippable strip 532 from the file bag 5, inside air is completely expelled out of the file bag 5, and the open side 52 is completely sealed by the double-sided adhesive tape 531 (see FIGS. 6D and 7).

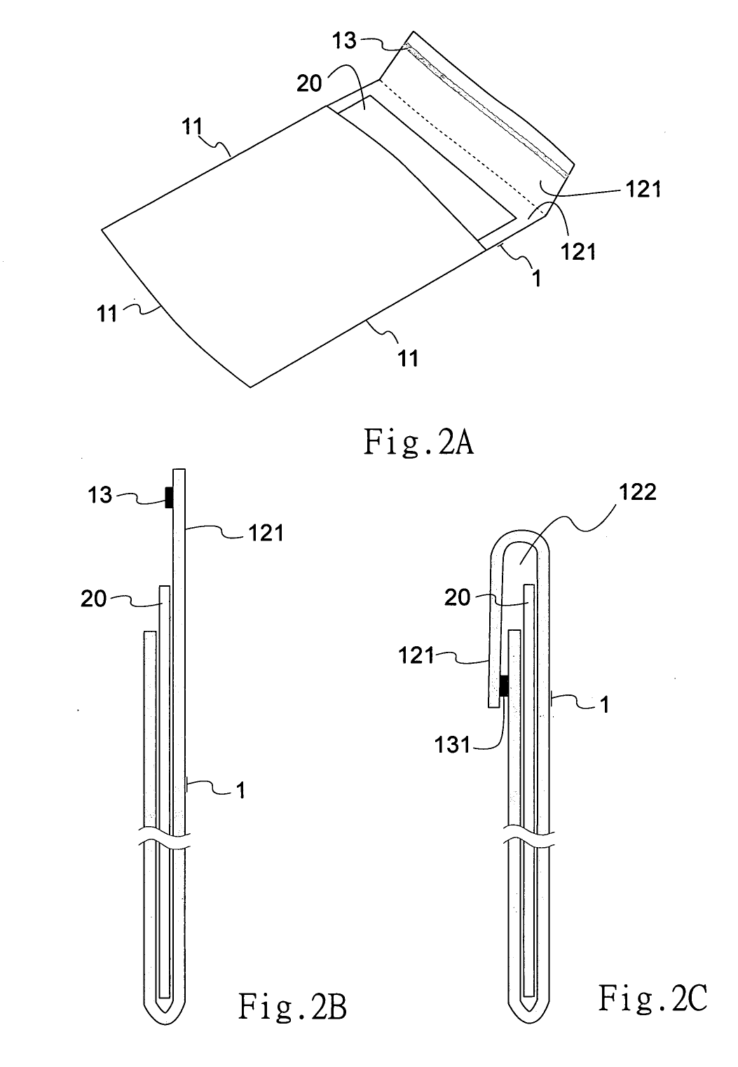

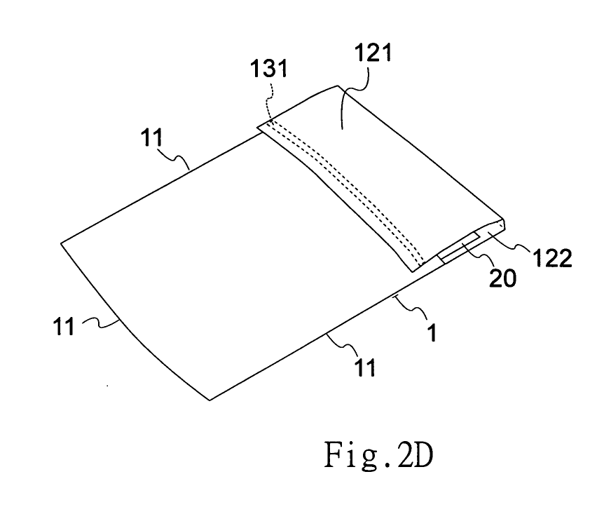

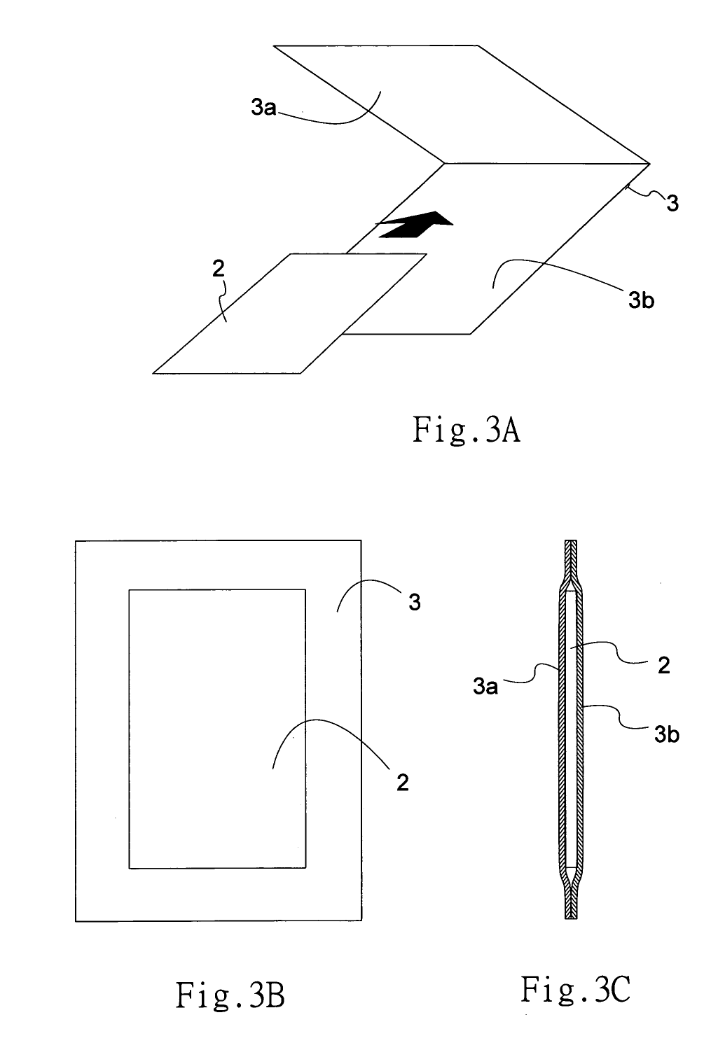

From the illustration of FIGS. 6A, 6B, and 6C, it is clear that the inside air can be completely expelled out of the file bag 5 by separating the strippable strip 532 from the sealing tape 53 and moving the hand over the file bag 5 to flatten the file bag 5 step by step. Because the sealing tape 53 has two distal ends connected to the sealing lines 511 at the two opposite closed sides 51, see FIG. 5, the file bag 5 can be sealed in a good sealing status, see FIG. 7, to well protect the storage paper documents against water or dust, unlike traditional file bag 1 shown in FIG. 2D, which has two openings 122 left at two opposite lateral sides through which water or dust can pass to wet or contaminate the storage file 20 after the cover flap 121 has been closed and sealed.

FIG. 7 is a cross-sectional view taken in an enlarged scale along the open side of the file bag 5. As indicated, the double-sided adhesive tape 531 seals the open side 52 of the file bag 5. Working with the sealing effect of the sealing lines 511, the double-sided adhesive tape 531 effectively seals the file bag 5 in a watertight status.

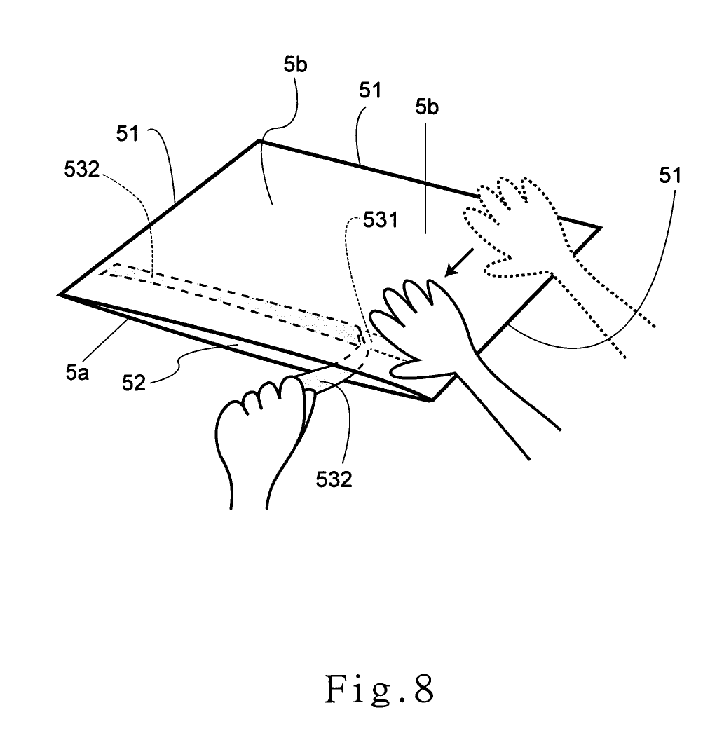

FIG. 8 is a schematic drawing showing the sealing operation of the present invention.

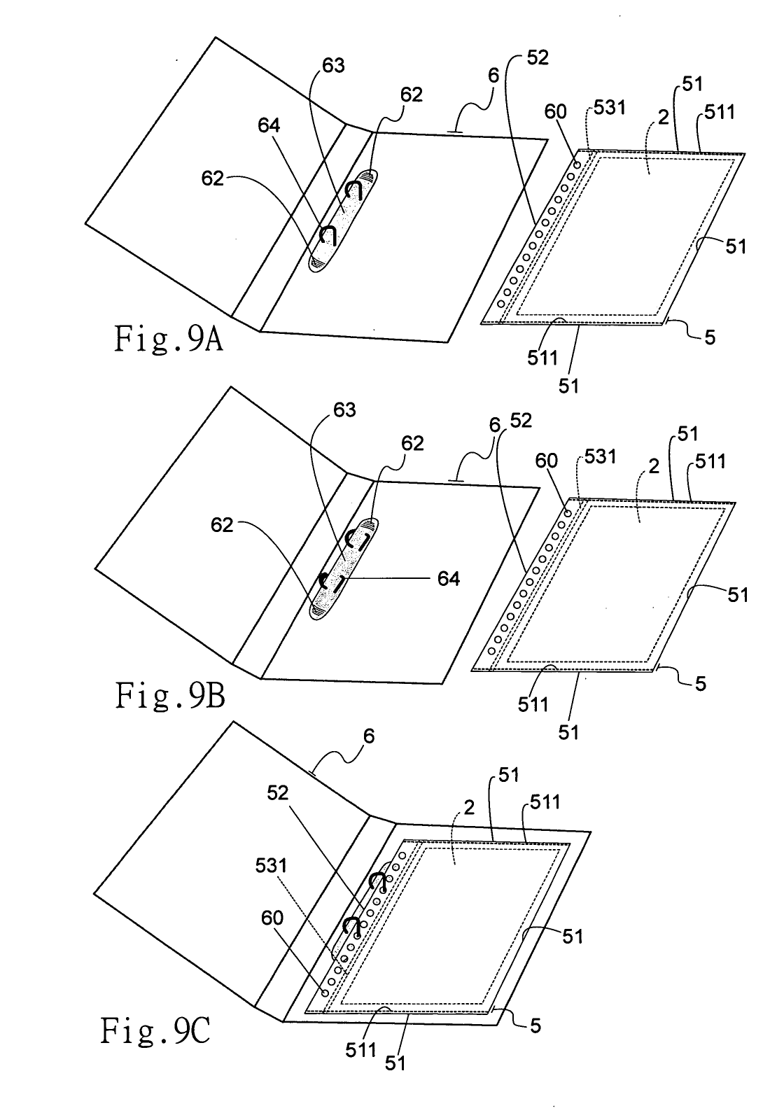

FIGS. 9A, 9B, and 9C show an alternate form of the present invention. According to this embodiment, the self-adhesive file bag 5 is made in the form of a loose-leaf sheet member, having a plurality of through holes 60 transversely aligned in a line along the open side 52 for fastening to a ring binder 6. The ring binder 6 comprises a ring clamp 63 loose-leaf sheet members or the like. The ring clamp 63 comprises a plurality of split rings 64, and two switching levers 62 operatable to open the split rings 64. After the file 2 has been sealed in the self-adhesive file bag 5, the split rings 64 are opened, and then the self-adhesive file bag 5 is put in the ring binder 6 to couple the through holes 60 to the split rings 64, and then the split rings 64 are closed to secure the self-adhesive file bag 5 to the ring binder 6.

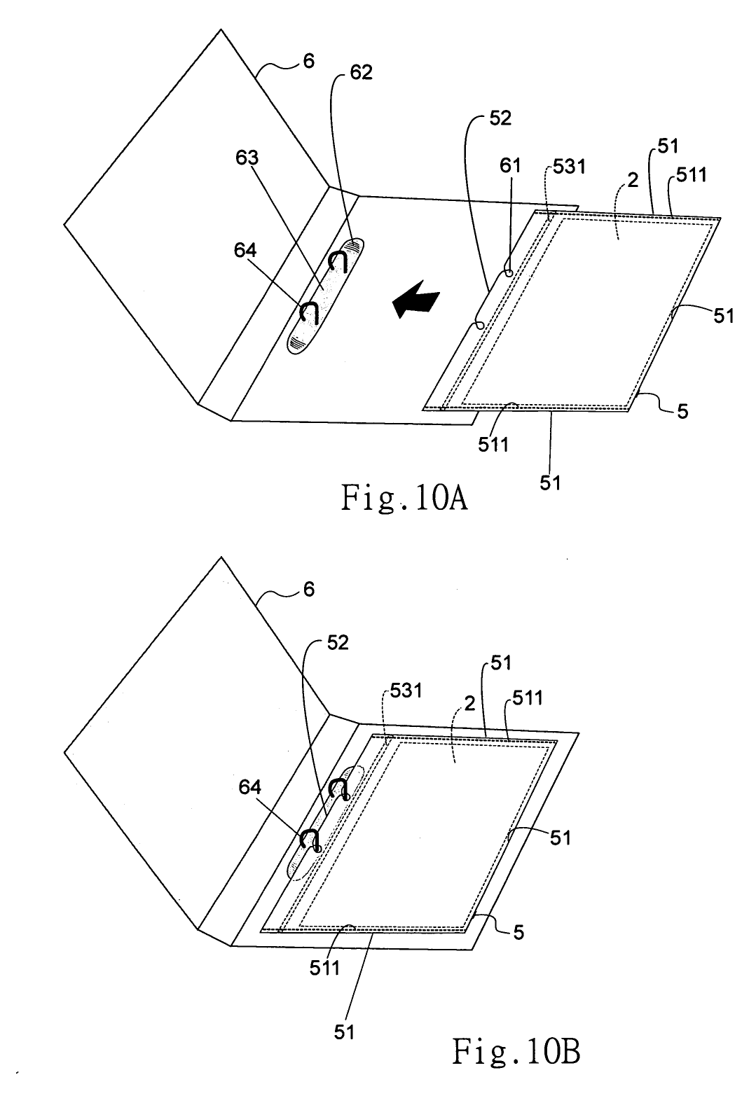

FIGS. 10A and 10B show another alternate form of the present invention. According to this embodiment, the self-adhesive file bag 5 has a plurality of peripheral holes 60 transversely aligned in a line along the open side 52 for fastening to a ring binder 6. Each of the peripheral holes 60 has a small part extended to the peripheral edge of the open side 52 of the self-adhesive file bag 5 so that the user can directly engage the split rings 64 into the peripheral holes 60 without opening the split rings 64.

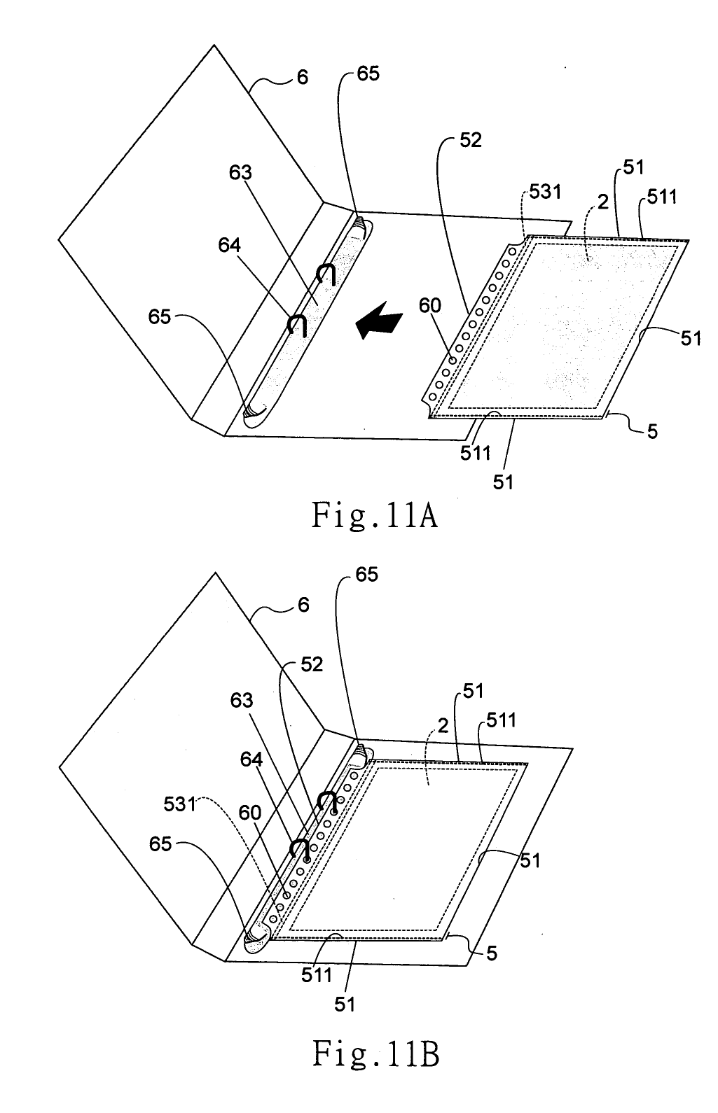

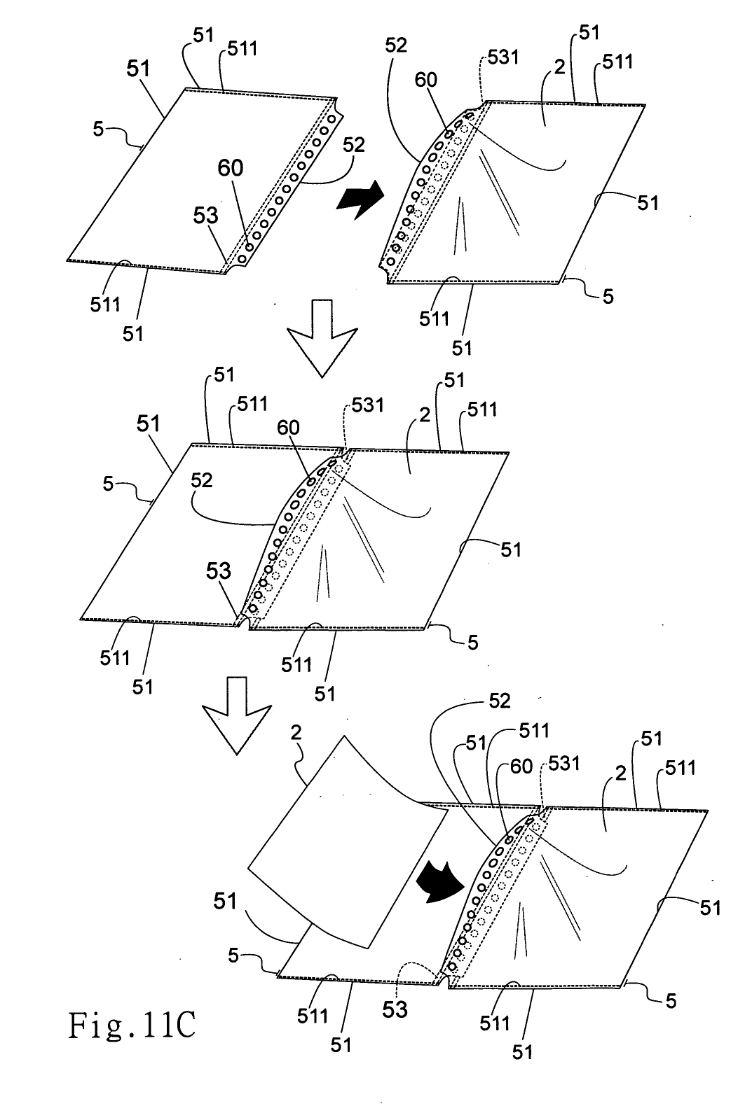

FIGS. 11A and 11B show still another alternate form of the present invention. According to this embodiment, the open side 52 of the self-adhesive file bag 5 has a part of each of the two distal ends cut off corresponding to the two end clamping lugs 65 of a ring binder 63. Therefore, the end clamping lugs 65 do not hinder installation of the self-adhesive file bag 5 in the ring binder 63.

Referring to FIG. 11C, when wishing to use the self-adhesive file bag 5 repeatedly after removing the strippable strip, the open side 52 of the self-adhesive file bag 5 is opened, and then a second self-adhesive file bag 5 is partially inserted into the open side 52 of the first self-adhesive file bag 5, and then the file 2 is inserted through the open side 52 of the first self-adhesive file bag 5 over the second self-adhesive file bag 5 into the inside of the first self-adhesive file bag 5, and then the second self-adhesive file bag 5 is removed from the first self-adhesive file bag 5, and then the open side of the first self-adhesive file bag 5 is sealed again.

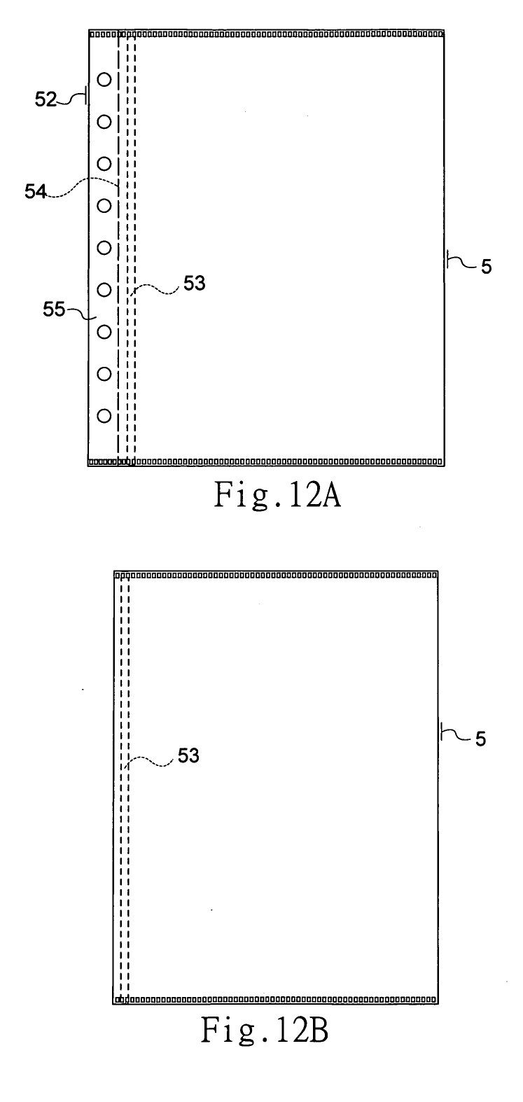

FIG. 12A shows still another alternate form of the present invention. According to this embodiment, a tear-off line 54 is provided at an outer side of the sealing tape 53, defining a strippable portion 55 at the open side 52. Through the tear-off line 54, the strippable portion 55 can easily be separated from the self-adhesive file bag 5, and the self-adhesive file bag 5 can be used for holding a photo or the like, and the sealing tape 53 can be sealed to close the self-adhesive file bag 5 after the storage item has been received in the self-adhesive file bag 5 (see FIG. 12B), keeping the storage item well protected against outside wet air.

As indicated above, the invention has the following advantages:

1. The open side of the self-adhesive file bag can be completely sealed to well protect the storage file against water and dust.

2. The self-adhesive file bag can be used anywhere when desired to well protect the storage file against water and dust instead of the use of a laminator.

3. The application of the present invention does not damage the storage file, and it keeps the storage file intact.

4. The self-adhesive file bag is repeatedly usable.

5. By means of separating the strippable strip from the sealing tape and moving the hand over the self-adhesive file bag to flatten the self-adhesive file bag step by step, air can be completely expelled out of the self-adhesive file bag. Thus it keeps the self-adhesive file bag in a flat status to be easily carried with the storage file.

Although particular embodiments of the invention have been described in detail for purposes of illustration, various modifications and enhancements may be made without departing from the spirit and scope of the invention.

What the invention claimed is:

1. A self-adhesive file bag comprising a rectangular plastic bag body formed of an upper layer and a bottom layer and having three closed sides and one open side between two opposite closed sides of said three closed sides, characterized in that a sealing tape is provided in said open side and operatable to close/open said open side, said sealing tape comprising a strippable strip and a double-sided adhesive tape and having two distal ends respectively sealed to said two opposite closed sides.

2. The self-adhesive file bag as claimed in claim 1, wherein said rectangular plastic bag body has a plurality of through holes aligned in a line in said open side in front of said sealing tape.

3. The self-adhesive file bag as claimed in claim 1, wherein said rectangular plastic bag body has a plurality of peripheral holes aligned in a line in said open side in front of said sealing tape.

4. The self-adhesive file bag as claimed in claim 1, wherein said sealing tape has a tear-off line provided at an outer side, defining a strippable portion.
